(19) United States
(12) Patent Application Publication
(10) Pub. No.: US 2026/0189001 A1
(43) Pub. Date: Jul. 2, 2026

(54) Integrated circuit and spike suppression circuit thereof

(71) Applicant: REALTEK SEMICONDUCTOR CORPORATION, HSINCHU (TW)

(72) Inventors: JIUN-HUNG PAN, HSINCHU (TW); TSUNG-TAO WU, HSINCHU (TW)

(21) Appl. No.: 19/423,626

(22) Filed: Dec. 17, 2025

(30) Foreign Application Priority Data
Dec. 27, 2024 (TW) 113151351

(51) Int. Cl. H02H 9/04; H02H 1/00

(52) U.S. Cl. CPC H02H 9/046; H02H 1/0007

(57) ABSTRACT

An integrated circuit includes a first pin and a second pin. A spike suppression circuit of the integrated circuit includes a switch and a detection circuit. The switch is coupled between the first pin and the second pin. The detection circuit is coupled to the first pin and a control terminal of the switch and is used to detect a spike on the first pin. When the detection circuit detects the spike, the detection circuit controls the switch to turn on.

### BACKGROUND OF THE INVENTION

### 1. Field of the Invention

The present invention generally relates to electrostatic discharge (ESD), and more particularly, to the spike suppression.

### 2. Description of Related Art

FIG. 1 shows the schematic diagram of a conventional ESD cell. The integrated circuit (IC) 100 has two pins (110 and 120), and includes a functional circuit 130, an ESD cell 140, and an ESD cell 150. The ESD cell 140 and the ESD cell 150 can provide spike protection for the functional circuit 130. More specifically, when there is a transient over-shoot spike current on the pin 110 (or the pin 120), the ESD cell 140 (or the ESD cell 150) provides a discharge path to prevent the spike current from damaging the functional circuit 130. However, if the slew rate of the spike current is too fast, causing the ESD cell 140 or the ESD cell 150 to respond inadequately, or if the spike current exceeds the discharge capacity of the ESD cell 140 or the ESD cell 150, the functional circuit 130 will be damaged.

### SUMMARY OF THE INVENTION

In view of the issues of the prior art, an object of the present invention is to provide an integrated circuit and a spike suppression circuit thereof, so as to make an improvement to the prior art.

According to one aspect of the present invention, a spike suppression circuit is provided. The spike suppression circuit is applied to an integrated circuit. The integrated circuit includes a first pin and a second pin. The spike suppression circuit includes a switch and a detection circuit. The switch is coupled between the first pin and the second pin. The detection circuit is coupled to the first pin and a control terminal of the switch and is configured to detect a spike on the first pin. When the detection circuit detects the spike, the detection circuit controls the switch to turn on.

According to another aspect of the present invention, an integrated circuit is provided. The integrated circuit includes a first pin, a second pin, a switch, and a detection circuit. The switch is coupled between the first pin and the second pin. The detection circuit is coupled to the first pin and a control terminal of the switch and is configured to detect a spike on the first pin. When the detection circuit detects the spike, the detection circuit controls the switch to turn on.

The technical means embodied in the embodiments of the present invention can solve at least one of the problems of the prior art. Therefore, compared to the prior art, the present invention can effectively suppress spikes.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows the schematic diagram of a conventional ESD cell.

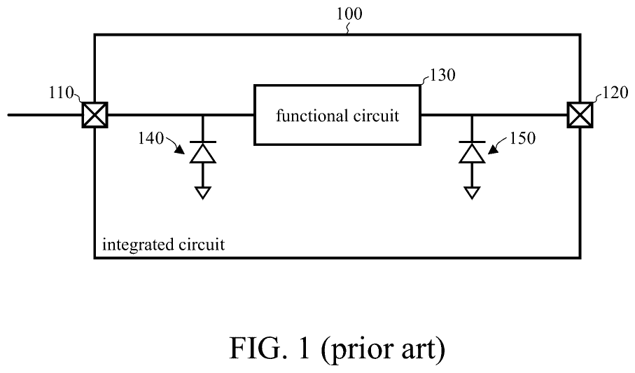

FIG. 2 is the circuit diagram of a spike suppression circuit according to an embodiment of the present invention.

FIG. 3 is the circuit diagram of a control circuit and a detection circuit according to an embodiment of the present invention.

FIG. 4 is the circuit diagram of a control circuit and a detection circuit according to another embodiment of the present invention.

FIG. 5 is the circuit diagram of a spike suppression circuit according to another embodiment of the present invention.

FIG. 6 is the circuit diagram of a clamping circuit according to an embodiment of the present invention.

FIG. 7 is the circuit diagram of a clamping circuit according to another embodiment of the present invention.

FIG. 8 is the circuit diagram of a clamping circuit according to another embodiment of the present invention.

FIG. 9 is the circuit diagram of a clamping circuit according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an integrated circuit and a spike suppression circuit thereof. On account of that some or all elements of the integrated circuit and the spike suppression circuit thereof could be known, the detail of such elements is omitted provided that such detail has little to do with the features of this disclosure, and that this omission nowhere dissatisfies the specification and enablement requirements. A person having ordinary skill in the art can choose components or steps equivalent to those described in this specification to carry out the present invention, which means that the scope of this invention is not limited to the embodiments in the specification.

In the following discussion, each transistor has a first terminal, a second terminal, and a control terminal. When the transistor is used as a switch, the first terminal and the second terminal of the transistor are the two terminals of the switch, and the control terminal is used to control the switch to turn on (the transistor is turned on) or turned off (the transistor is turned off). For a Metal-Oxide-Semiconductor Field-Effect Transistor (MOSFET), the first terminal may be one of the source and the drain, the second terminal may be the other of the source and the drain, and the control terminal is the gate. For a bipolar junction transistor (BJT), the first terminal may be one of the collector and the emitter, the second terminal may be the other of the collector and the emitter, and the control terminal is the base.

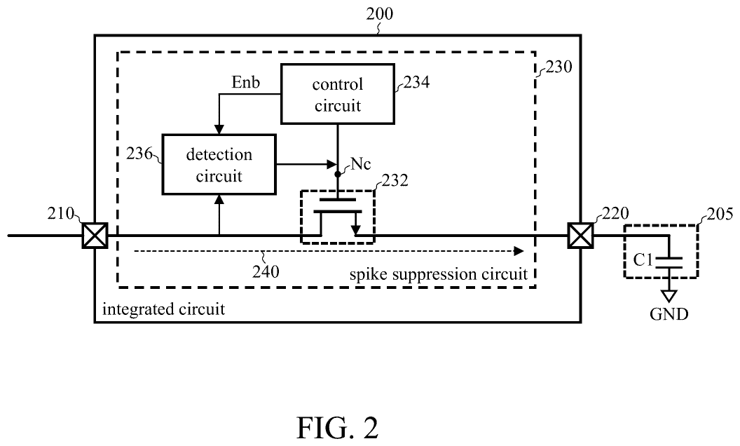

Reference is made to FIG. 2, which is the circuit diagram of a spike suppression circuit according to an embodiment of the present invention. The integrated circuit 200 includes a pin 210, a pin 220, and a spike suppression circuit 230. The spike suppression circuit 230 includes a switch 232, a control circuit 234, and a detection circuit 236, all of which are coupled to one another. The spike suppression circuit 230 is used to provide spike suppression for a functional circuit (not shown) of the integrated circuit 200.

The switch 232 is coupled between the pin 210 and the pin 220, and is controlled by the control circuit 234. When the switch 232 is turned on, the pin 210 is substantially electrically connected to the pin 220. At this time, the spike on the pin 210 can be discharged through the spike current absorption device 205 connected to the pin 220.

The spike current absorption device 205 is disposed outside the integrated circuit 200, and the spike current absorption device 205 and the integrated circuit 200 are both mounted on a circuit board (not shown).

In some embodiments, the spike current absorption device 205 is embodied by the capacitor C1. The capacitor C1 can serve as a voltage-stabilizing capacitor, the switch 232 is a power switch, and the pin 220 receives the power supply voltage from outside the integrated circuit 200. One terminal of the capacitor C1 is coupled or electrically connected to the pin 220; the other terminal of the capacitor C1 is coupled or electrically connected to the reference voltage GND. When the switch 232 is turned on, the integrated circuit 200 supplies power to other components through the pin 210.

In an alternative embodiment, the spike current absorption device 205 can be embodied by a clamping circuit or an ESD cell. ESD cells include but are not limited to transient voltage suppressor (TVS) diodes, Zener diodes, and/or general diodes.

In an alternative embodiment, the spike current absorption device 205 may be a combination of at least two of a capacitor, a clamping circuit, and an ESD cell.

In the embodiment of FIG. 2, the switch 232 is embodied by an N-channel Metal-Oxide-Semiconductor Field-Effect Transistor (hereinafter referred to as an NMOS transistor). However, the switch 232 can also be embodied by a P-channel Metal-Oxide-Semiconductor Field-Effect Transistor (hereinafter referred to as a PMOS transistor) or a bipolar junction transistor (BJT). People having ordinary skill in the art know how to implement a power switch using a PMOS and a BJT, so further elaboration is omitted for brevity.

One terminal of the switch 232 (e.g., the drain) is coupled or electrically connected to the pin 210; another terminal of the switch 232 (e.g., the source) is coupled or electrically connected to the pin 220; the control terminal Nc (e.g., the gate) of the switch 232 is coupled or electrically connected to the control circuit 234.

When the integrated circuit 200 provides power to other components through the pin 210, the control circuit 234 controls the switch 232 to turn on. At this time, because the discharge path 240 has been established, the detection circuit 236 can be temporarily turned off to save power. That is to say, when the control circuit 234 controls the switch 232 to turn on, the control circuit 234 disables the detection circuit 236 via the control signal Enb. When the control circuit 234 controls the switch 232 to turn off, the control circuit 234 enables the detection circuit 236 via the control signal Enb.

The detection circuit 236 detects the spike on the pin 210, and controls the switch 232 to turn on or off according to the detection result. More specifically, when the detection circuit 236 detects a spike on the pin 210, the detection circuit 236 controls the switch 232 to turn on, thereby establishing a discharge path 240 between the pin 210 and the pin 220. In this way, the spike is discharged to the spike current absorption device 205, and thus the functional circuit in the integrated circuit 200 is protected.

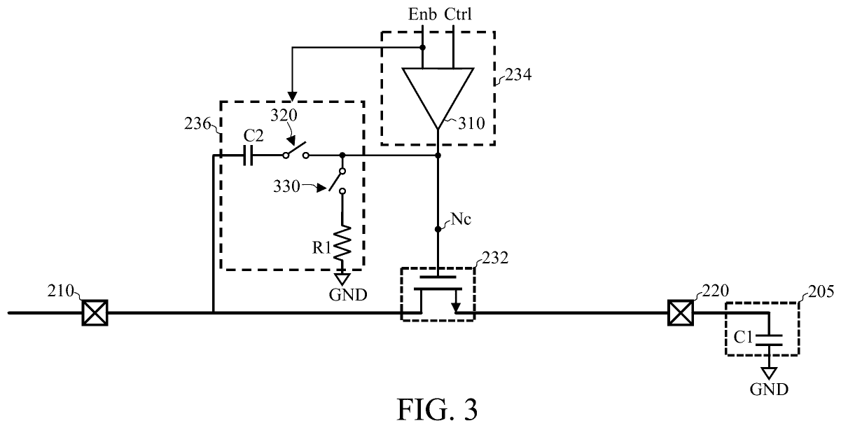

Reference is made to FIG. 3, which is a circuit diagram of a control circuit and a detection circuit according to an embodiment of the present invention. The control circuit 234 includes a buffer circuit 310 (which can also be referred to as a driving circuit). The buffer circuit 310 controls the voltage at the control terminal Nc of the switch 232 according to the control signal Ctrl. In some embodiments, the buffer circuit 310 can be embodied by one or more inverters.

The detection circuit 236 includes a capacitor C2, a resistor R1, a switch 320, and a switch 330.

One terminal of the capacitor C2 is coupled or electrically connected to the pin 210; the other terminal of the capacitor C2 is coupled or electrically connected to the switch 320.

One terminal of the resistor R1 is coupled or electrically connected to the switch 330; the other terminal of the resistor R1 is coupled or electrically connected to a reference voltage GND (e.g., ground). In an alternative embodiment, the resistor R1 can be replaced by an impedance formed by an NMOS transistor and/or a PMOS transistor.

One terminal of the switch 320 is coupled or electrically connected to the capacitor C2; another terminal of the switch 320 is coupled or electrically connected to the control terminal Nc of the switch 232; the control terminal of the switch 320 receives the control signal Enb.

One terminal of the switch 330 is coupled or electrically connected to the control terminal Nc of the switch 232; another terminal of the switch 330 is coupled or electrically connected to the resistor R1; the control terminal of the switch 330 receives the control signal Enb.

In the embodiment of FIG. 3, the detection circuit 236 is a high-pass filter (HPF). When a spike occurs on the pin 210, the spike passes through the detection circuit 236, increasing the voltage at the control terminal Nc, which causes the switch 232 to turn on, thereby achieving the purpose of discharging (i.e., discharging the spike).

It should be noted that, in some embodiments, if the power consumption of the detection circuit 236 can be ignored (i.e., it does not need to be disabled), the switch 320 and the switch 330 can be omitted.

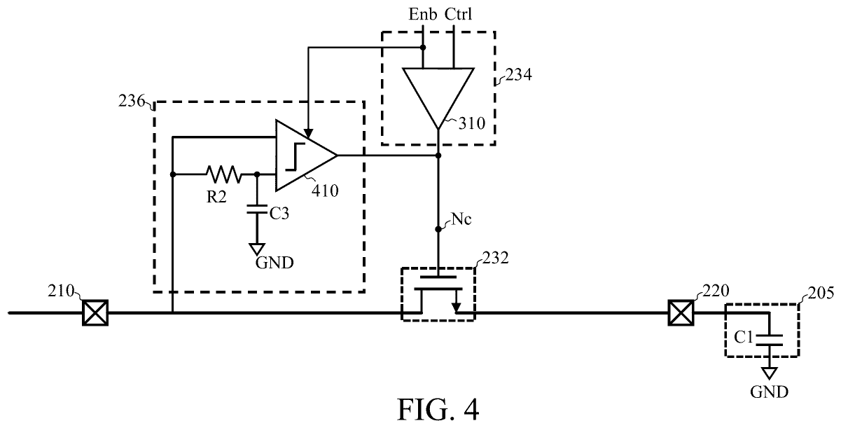

Reference is made to FIG. 4, which is a circuit diagram of a control circuit and a detection circuit according to another embodiment of the present invention. The control circuit 234 in FIG. 4 is the same as the control circuit 234 in FIG. 3. In the embodiment of FIG. 4, the detection circuit 236 includes a comparator 410, a resistor R2, and a capacitor C3.

One input terminal of the comparator 410 is coupled or electrically connected to the capacitor C3 and the resistor R2; the other input terminal of the comparator 410 is coupled or electrically connected to the pin 210; the output terminal of the comparator 410 is coupled or electrically connected to the control terminal Nc of the switch 232.

One terminal of the resistor R2 is coupled or electrically connected to the pin 210; the other terminal of the resistor R2 is coupled or electrically connected to the comparator 410.

One terminal of the capacitor C3 is coupled or electrically connected to the comparator 410; the other terminal of the capacitor C3 is coupled or electrically connected to the reference voltage GND.

The resistor R2 and the capacitor C3 substantially constitute a low-pass filter (LPF). In an alternative embodiment, the resistor R2 can be replaced by an impedance formed by an NMOS transistor and/or a PMOS transistor.

When there is no spike on the pin 210 (i.e., the voltage on the pin 210 does not fluctuate drastically), the two input terminals of the comparator 410 receive substantially the same voltage. At this time, the comparator 410 outputs a first voltage level (e.g., a low level) to control the switch 232 to turn off.

When there is a spike on the pin 210 (i.e., the voltage on the pin 210 changes instantaneously), the voltages at the two input terminals of the comparator 410 are different (due to the low-pass filter). At this time, the comparator 410 outputs a second voltage level (e.g., a high level) to control the switch 232 to turn on.

When the buffer circuit 310 drives the switch 232 to turn on, the detection circuit 236 can be turned off (i.e., using the control signal Enb to turn off the comparator 410) to reduce power consumption.

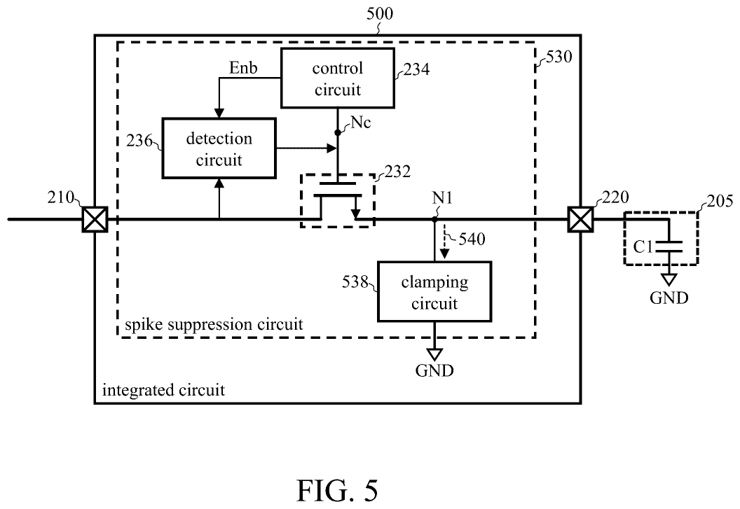

Reference is made to FIG. 5, which is the circuit diagram of a spike suppression circuit according to another embodiment of the present invention. The integrated circuit 500 includes the pin 210, the pin 220, and a spike suppression circuit 530. The spike suppression circuit 530 includes the switch 232, the control circuit 234, the detection circuit 236, and a clamping circuit 538. One terminal of the clamping circuit 538 is coupled or electrically connected to the node N1 (i.e., the pin 220 and one terminal of the switch 232); the other terminal of the clamping circuit 538 is coupled or electrically connected to the reference voltage GND. The clamping circuit 538 aims to provide an additional discharge path 540.

Compared to the spike suppression circuit 230, the spike suppression circuit 530 has a higher current discharge capability, and therefore, has a better spike suppression effect. More specifically, because a higher current discharge capability can slow down the slew rate of the spike current, the spike suppression circuit 530 has a better spike suppression effect.

In some embodiments, the objective of the spike suppression circuit 230 and the spike suppression circuit 530 is to limit the rate of voltage rise at the pin 210 to less than one volt per microsecond (v/μs). The higher the aforementioned current discharge capability, the lower the rate of voltage rise.

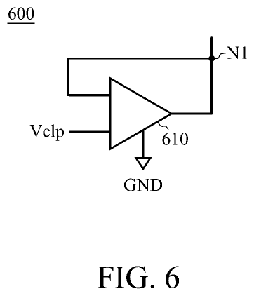

Reference is made to FIG. 6, which is the circuit diagram of a clamping circuit according to an embodiment of the present invention. The clamping circuit 538 of FIG. 5 can be embodied by the loop circuit 600. The loop circuit 600 includes an operational amplifier 610. The first input terminal of the operational amplifier 610 receives the reference voltage Vclp; the second input terminal of the operational amplifier 610 is coupled or electrically connected to the node N1; the output terminal of the operational amplifier 610 is coupled or electrically connected to the node N1. When the voltage at the node N1 is less than the reference voltage Vclp, the loop circuit 600 activates to provide the additional discharge path 540.

The reference voltage Vclp is related to the operating voltage (Vx) at the pin 210. In some embodiments, the reference voltage Vclp can be substantially equal to 1.1*Vx.

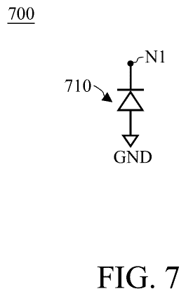

Reference is made to FIG. 7, which is the circuit diagram of a clamping circuit according to another embodiment of the present invention. The clamping circuit 538 can be embodied by the ESD cell 700. In the embodiment of FIG. 7, the ESD cell 700 is a general diode 710. The anode of the diode 710 is coupled or electrically connected to the reference voltage GND; the cathode of the diode 710 is coupled or electrically connected to the node N1.

In an alternative embodiment, the ESD cell 700 may be an input/output (IO) circuit, a Zener diode, a MOSFET, a BJT, or a combination thereof.

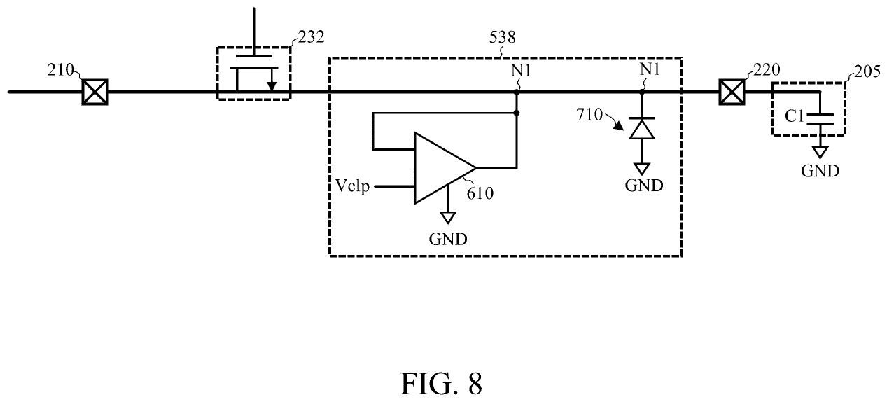

In an alternative embodiment, the clamping circuit 538 may be a combination of the loop circuit 600 and the ESD cell 700 (as shown in FIG. 8).

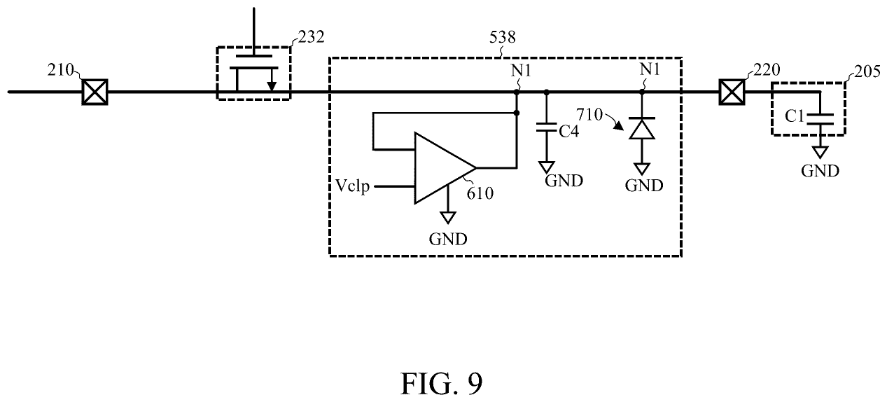

In an alternative embodiment, the clamping circuit 538 may be a combination of the loop circuit 600, the ESD cell 700, and a capacitor C4 (as shown in FIG. 9).

In summary, the present invention uses the detection circuit 236 to detect spikes, and immediately turns on the switch 232 to establish a discharge path upon detection of a spike, thereby quickly and effectively suppressing the spike. In addition, the present invention further provides an additional discharge path to improve the effect of spike suppression.

Note that the shape, size, and ratio of any element in the disclosed figures are exemplary for understanding, not for limiting the scope of this invention.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A spike suppression circuit applied to an integrated circuit comprising a first pin and a second pin, the spike suppression circuit comprising:
a switch coupled between the first pin and the second pin; and
a detection circuit coupled to the first pin and a control terminal of the switch and configured to detect a spike on the first pin;
wherein when the detection circuit detects the spike, the detection circuit controls the switch to turn on.

2. The spike suppression circuit of claim 1, wherein when the switch is turned on, a discharge path is established between the first pin and the second pin.

3. The spike suppression circuit of claim 2, wherein the detection circuit comprises:
a capacitor, wherein a terminal of the capacitor is coupled to the first pin, and another terminal of the capacitor is coupled to the control terminal of the switch; and
a resistor, wherein a terminal of the resistor is coupled to the control terminal of the switch, and another terminal of the resistor is coupled to a reference voltage.

4. The spike suppression circuit of claim 2, wherein the detection circuit comprises:
a comparator having a first input terminal, a second input terminal, and an output terminal, wherein the first input terminal is coupled to the first pin, and the output terminal is coupled to the control terminal of the switch;
a resistor, wherein a terminal of the resistor is coupled to the first pin, and another terminal of the resistor is coupled to the second input terminal; and
a capacitor, wherein a terminal of the capacitor is coupled to the second input terminal, and another terminal of the capacitor is coupled to a reference voltage.

5. The spike suppression circuit of claim 2, wherein the discharge path is a first discharge path, and the spike suppression circuit further comprises:
a clamping circuit coupled to the switch and the second pin and configured to provide a second discharge path.

6. The spike suppression circuit of claim 5, wherein the clamping circuit comprises:
an operational amplifier having a first input terminal, a second input terminal, and an output terminal, wherein the first input terminal is coupled to the second pin, the output terminal is coupled to the second pin, and the second input terminal receives a reference voltage.

7. The spike suppression circuit of claim 2 further comprising:
a control circuit coupled to the control terminal of the switch and configured to control the switch to turn on to provide power through the first pin.

8. The spike suppression circuit of claim 7, wherein when the control circuit controls the switch to turn on, the control circuit disables the detection circuit.

9. The spike suppression circuit of claim 7, wherein the switch is a power switch.

10. An integrated circuit, comprising:
a first pin;
a second pin;
a switch coupled between the first pin and the second pin; and
a detection circuit coupled to the first pin and a control terminal of the switch and configured to detect a spike on the first pin;
wherein when the detection circuit detects the spike, the detection circuit controls the switch to turn on.

11. The integrated circuit of claim 10, wherein when the switch is turned on, a discharge path is established between the first pin and the second pin.

12. The integrated circuit of claim 11, wherein the detection circuit comprises:
a capacitor, wherein a terminal of the capacitor is coupled to the first pin, and another terminal of the capacitor is coupled to the control terminal of the switch; and
a resistor, wherein a terminal of the resistor is coupled to the control terminal of the switch, and another terminal of the resistor is coupled to a reference voltage.

13. The integrated circuit of claim 11, wherein the detection circuit comprises:
a comparator having a first input terminal, a second input terminal, and an output terminal, wherein the first input terminal is coupled to the first pin, and the output terminal is coupled to the control terminal of the switch;
a resistor, wherein a terminal of the resistor is coupled to the first pin, and another terminal of the resistor is coupled to the second input terminal; and
a capacitor, wherein a terminal of the capacitor is coupled to the second input terminal, and another terminal of the capacitor is coupled to a reference voltage.

14. The integrated circuit of claim 11, wherein the discharge path is a first discharge path, and the integrated circuit further comprises:
a clamping circuit coupled to the switch and the second pin and configured to provide a second discharge path.

15. The integrated circuit of claim 14, wherein the clamping circuit comprises:
an operational amplifier having a first input terminal, a second input terminal, and an output terminal, wherein the first input terminal is coupled to the second pin, the output terminal is coupled to the second pin, and the second input terminal receives a reference voltage.

16. The integrated circuit of claim 11 further comprising:
a control circuit coupled to the control terminal of the switch and configured to control the switch to turn on to provide power through the first pin.

17. The integrated circuit of claim 16, wherein when the control circuit controls the switch to turn on, the control circuit disables the detection circuit.

18. The integrated circuit of claim 16, wherein the switch is a power switch.
